(19) United States
(12) Patent Application Publication
(10) Pub. No.: US 2013/0340419 A1
(43) Pub. Date: Dec. 26, 2013

(54) AIR HANDLING SYSTEM

(71) Applicant: C/O NEW WORLD ENERGY ENTERPRISES LTD, Longford (IE)

(72) Inventors: James SMYTH, County Cavan (IE); Peter SMYTH, County Longford (IE); David SMYTH, County Longford (IE); Gerard SMYTH, County Longford (IE); Andrew SMYTH, County Armagh (IE)

(73) Assignee: c/o NEW WORLD ENERGY ENTERPRISES LTD, Longford (IE)

(21) Appl. No.: 13/851,233

(22) Filed: Mar. 27, 2013

(30) Foreign Application Priority Data
Jun. 20, 2012 (IE) 20120284

(51) Int. Cl. F03D 1/04; F15D 1/02

(52) U.S. Cl. CPC F03D 1/04; F15D 1/025
USPC 60/398; 137/807; 137/833

(57) ABSTRACT

An air handling system comprising an air guide in the form of a convergent divergent shroud and/or diffuser defining a path along which air can flow, such as to generate one or more regions of reduced pressure and/or increased mass flow rate of air within the guide in response to the passage of air through the guide, and a manifold extending from the guide and having an inlet and an exhaust, the exhaust being in fluid communication with the one or more regions of reduced pressure and/or increased mass flow rate and the inlet being in fluid communication with an interior of an air handling unit such as a condenser or air conditioning unit.

### REFERENCE TO RELATED APPLICATION

This application claims priority to Irish Patent Application No. S2012/0284, filed Jun. 20, 2012, the disclosure of which is incorporated herein by reference.

### BACKGROUND OF THE INVENTION

The use of air handling units such as condensers and air conditioning units is common, in particular in buildings such as residential apartment blocks, office buildings, manufacturing plants, etc. Such units are however costly to operate, and any mechanism to reduce the operating cost or improve the efficiency of such units is desirable.

It is therefore an object of the present invention to provide an air handling system which can reduce the cost of and/or increase the efficiency of such units.

It is a further object of the present invention to provided an air handling system which utilizes the natural flow of air past such buildings or the like in order to augment the performance of such condensers and/or air conditioning units.

### SUMMARY OF THE INVENTION

According to the present invention there is provided an air handling system comprising at least one air guide defining a path along which air can flow, the guide being shaped and dimensioned to generate one or more regions of reduced pressure and/or increased mass flow rate of air within the guide in response to the passage of air through the guide; and a manifold extending from the guide and having at least one exhaust in fluid communication with the one or more regions of reduced pressure and/or increased mass flow rate.

Preferably, the air guide comprises a duct.

Preferably, the air guide defines a convergent and/or divergent path along which air can flow.

Preferably, the air guide comprises a single section having a substantially continuous sidewall.

Preferably, the air guide comprises two or more sections separated from one another by a respective circumferentially extending gap.

Preferably, the system comprises a support on which the air guide is mounted, the manifold extending through or being formed integrally with the support.

Preferably, the air guide defines a restricted throat section at or adjacent which the at least one exhaust is located.

Preferably, the system comprises an air processing unit with which an intake of the manifold is in fluid communication in order to draw air from the air processing unit.

Preferably, the air processing unit comprises a heat exchanger in fluid communication with the intake of the manifold.

Preferably, the air processing unit comprises a supply duct through which air may be supplied from the air processing unit, and an exhaust duct through which air may be supplied to the air processing unit.

Preferably, the system comprises a set of blades disposed for rotation in the path defined by the air guide in order to extract power from the flow of air through the guide.

Preferably, the manifold passes through the air guide from an exterior to an interior thereof.

Preferably, the air processing unit comprises an air conditioning unit.

Preferably, the air processing unit comprises a compressor unit.

Preferably, the system comprises a housing mountable about the air processing unit, the intake being in fluid communication with the housing, and the housing being shaped and/or dimensioned to augment the flow of air into the manifold.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 illustrates a schematic representation of an air handling system according to an embodiment of the present invention, and comprising a condenser unit; and

FIG. 2 illustrates an alternative embodiment of the air handling system according to the present invention, and comprising an air conditioning unit.

### DETAILED DESCRIPTION OF THE DRAWINGS

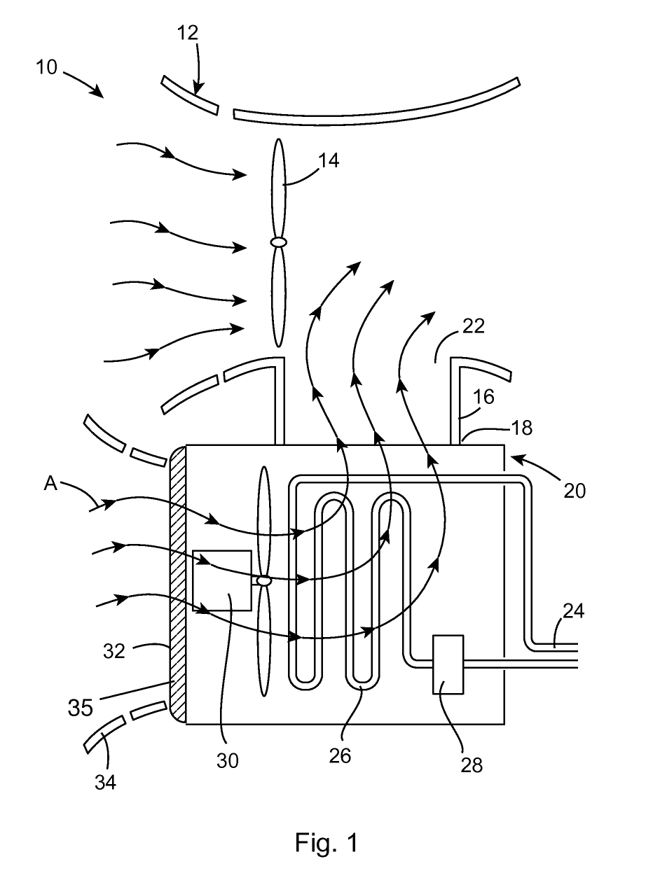

Referring now to FIG. 1 of the accompanying drawings there is illustrated an air handling system, generally indicated as 10, which is designed to augment, and in particular to increase, the flow of air through an air-handling unit such as a condenser or air conditioning unit, and/or reduce the power requirements for operating the air-handling unit.

The air-handling system 10 comprises an air guide 12 in the form of duct which in the embodiment illustrated comprises a convergent divergent shroud, but may additionally or alternatively comprise a diffuser (not shown) which, in use, is placed in the open air such that exterior air can flow naturally through the air guide 12, as will be described in greater detail hereinafter. Thus for example the air guide 12 may be placed on the roof of a building, or elevated by some other means. As it is conventional practice to locate such air handling units on the roof of the respective building serviced by the unit, it should be a relatively straightforward operation to also locate the air guide 12 directly adjacent the air handling unit.

The shape of the air guide 12 may be varied in order to alter the flow characteristics of air through the guide 12, and may for example be provided as a single section of ducting, or alternatively in a number of sections each separated from the adjacent section by a circumferential gap, for example as described and shown in the applicant's International patent application number PCT/EP2010/058655 or co-pending Irish patent application number S2011/0512.

The air handling system 10 may optionally comprise a bladed turbine 14 disposed internally of the air guide 12, such that the flow of air through the air guide 12 will drive the turbine 14, for example to generate mechanical or electrical energy. This may be extracted from the turbine 14 by any suitable means, which will not be described in any further detail hereinafter.

The air handling system 10 additionally comprises a manifold 16, which has an inlet 18 in fluid communication with an air handling unit in the form of a substantially conventional condenser 20, and an exhaust 22 formed in a sidewall of the air guide 12 such that air can flow from the manifold 16 into the air guide 12. The exhaust 22 is preferably located at or adjacent a throat region of the convergent divergent air guide 12, although this position may be varied as required in order to achieve desired operating parameters, again as will be described hereinafter.

The condenser 20 is substantially conventional in form, and may be located at any suitable location, for example about a building or the like, although it is preferable that the length of the manifold 16 is as short as possible in order to minimize losses in the velocity of the air flowing through the manifold and into the air guide 12. Thus it would be preferable that the condenser 20 is mounted on the roof of a building adjacent to the air guide 12. In the embodiment illustrated the air guide 12 is positioned above the condenser 20, with the inlet 18 being provided or formed in an upper wall of the condenser 20. It should however be understood that the air guide 12 could be located in any other suitable position and/or orientation relative to the condenser 20. For example the air guide 12 could be located alongside the condenser 20, and the inlet 18 could then be formed in a sidewall of the condenser 20 in order to again minimize the length of the manifold 16.

The condenser 20 comprises coolant lines 24 which define condenser coils 26, which feed into a compressor 28 in conventional fashion. The condenser 20 further comprises a fan 30 for blowing air over the condenser coils 26, said air being drawn in from an intake 32 at a front of the condenser 20. It will of course be appreciated that the exact components, and/or the positioning of said components, within the condenser 20 may be varied.

In order to increase the airflow into the condenser 20 via the intake 32, it is preferable that the air handling system 10 further comprises a cowl 34 mounted about the intake 32 in order to funnel additional air into the interior of the condenser 20. Again the shape of the cowl 34 may be varied in order to alter the flow characteristics of air through the cowl 34 and into the condenser 20, and may for example be provide in a number of sections, for example as described and shown in the applicant's International patent application number PCT/EP2010/058655 or co-pending Irish patent application number S2011/0512. It may be necessary or desirable, in particular in light of the shape of the front face of the condenser 20 to which the cowl 34 is mounted, to utilize an adapter or coupling 35 between the cowl 34 and the front face of the condenser 20. It should also be noted that the cowl 34 may be located on any other suitable face of the condenser 20 which will permit air to be drawn into the condenser 20.

Turning then to the operation of the air handling system 10, as the air guide 12 is located in a position exposed to exterior air flow, air will flow into the air guide 12, with the shape of the air guide 12 serving to accelerate the air through the guide, and where the turbine 14 is present, across the blades of the turbine in order to drive rotation of the turbine 14 in order to generate electricity or the like. Due to the convergent divergent shape of the air guide 12 in the embodiment illustrated, airflow through the air guide 12 will result in a region, in the present case about the throat of the air guide 12, of reduced pressure and increased velocity. This region of reduced pressure and increased velocity substantially coincides with the position of the exhaust 22, and will therefore result in air being drawn up through the manifold 16 from the condenser 20. Thus the air guide 12 acts to draw air through the condenser 20, thus aiding the operation of condenser 20. In particular the increased air flow across the condenser coils 26 will result in an increase in the cooling of the working fluid flowing through the coils 26, thereby increasing the workload or decreasing the power consumption of the condenser 20.

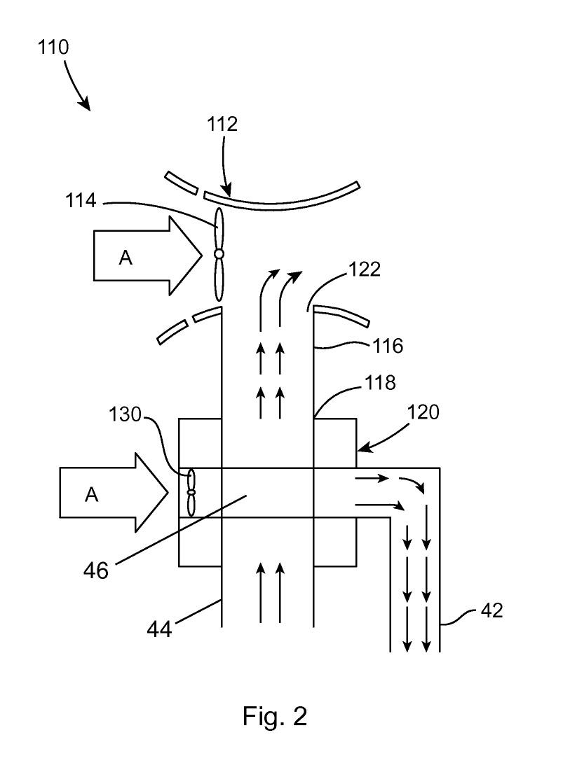

Turning then to FIG. 2 there is illustrated an alternative embodiment of an air handling system according to the present invention, generally indicated as 110. In this alternative embodiment like components have been accorded like reference numerals and unless otherwise stated perform a like function.

The air handling system 110 comprises an air guide 112, which optionally includes a bladed turbine 114 disposed internally thereof. The handling system 110 further comprises a manifold 116 having an inlet 118 in fluid communication with an air-handling unit in the form of an air conditioner 120, and an exhaust 122 that is formed in a sidewall of the air guide 112, preferably about a throat region thereof.

Although not illustrated, the air conditioner 120 comprises conventional internals in order to heat/cool, and/or remove moisture from the air in conventional fashion. The air conditioner 120 further comprises a first fan 130 mounted adjacent a front of the air conditioner 120 for blowing air over the internal components (not shown) and through the mouth of a supply duct 42 extending from the air conditioner 120, via which conditioned air is supplied to any desired location, for example the internal spaces of a building or the like. A return or exhaust duct 44 draws air from within the air conditioned space, for example the interior of a building, the exhaust duct 44 passing upwardly through the air conditioner 120 and into the manifold 116 before terminating at the exhaust 122 in the air guide 112. The supply duct 42 and exhaust duct 44 intersect one another within the air conditioner 120, a heat exchanger unit 46 being provided at the intersection in order to recover heat from the air passing through the exhaust duct 44. The recaptured heat may be transferred to the air flow within the supply duct 42, or may be used for other purposes. The heat exchange unit 46 may be of any suitable type. The supply duct 42 and exhaust duct 44, at their intersection, may thus be in thermal communication, but are not in fluid communication, by means of the heat exchange unit 46. Thus the air flows through the supply duct 42 and the exhaust duct 44 do not mix with one another.

In order to increase the airflow into the air conditioner 120 it is again preferable but not essential that the air handling system 110 comprises a cowl (not shown) similar to the cowl 34 illustrated in FIG. 1, and similarly mounted about an intake of the air conditioner 120 upstream of the first fan 130. The cowl will then serve to funnel additional air into the interior of the air conditioner 120. Again the shape of the cowl (not shown) may be varied in order to alter the flow characteristics of air through the cowl and into the air conditioner 120, and may for example be provide in a number of sections, for example as described and shown in the applicant's International patent application number PCT/EP2010/058655 or co-pending Irish patent application number S2011/0512. It may be necessary or desirable, in particular in light of the shape of the front face of the air conditioner 120 to which the cowl (not shown) is mounted, to utilize an adapter or coupling (not shown) between the cowl and the front face of the air conditioner 120. It should also be noted that the cowl may be located on any other suitable face of the air conditioner 120 which will permit air to be drawn into the air conditioner 120.

Turning then to the operation of the air handling system 110, the air guide 112 is again positioned in an area of free flowing air, for example the top of a building or the like. The air therefore naturally flows through the air guide 112 whose shape accelerates the airflow thus driving the turbine 114 if present. The convergent divergent shape of the air guide 112 of the embodiment illustrated results in a region of reduced pressure and/or increased velocity about the throat of the air guide 112 at which the exhaust 122 is located. This reduced pressure results in air being drawn through the manifold 116 and the exhaust duct 44, thus drawing air from the air conditioned space serviced by the air conditioner 120. As this air passes the heat exchange unit 46 heat may be recovered from the air flow, and optionally transferred to the air flow within the supply duct 42. This will again reduce the power load or increase the performance of the air conditioner 120. As with the first embodiment, it will be appreciated that the position of the air guide 112 relative to the air conditioner 120 may be varied, as may the position or face at which the inlet 118 is formed.

It will be appreciated that the air handling system 10, 110 may be utilized with alternative air handling units beyond the condenser and air conditioner hereinbefore described, in order to increase the air flow through such air handling units (not shown). It is also to be noted that the air guide 12, 112 could be mounted at an elevated position on a pole or similar upright support (not shown) in order to provide increased airflow through the air guide 12, 112. The support could, in such an embodiment, pass directly through the interior of the air guide 12, 112, and could be used to form an exhaust of the manifold 16, 116.

The present invention is not limited to the embodiments described herein, which may be amended or modified without departing from the scope of the present invention.

Therefore, it is intended that the appended claims be interpreted as including the embodiments described herein, the alternatives mentioned above, and all equivalents thereto.

What is claimed is:

1. An air handling system comprising at least one air guide defining a path along which air can flow, the guide being shaped and dimensioned to generate one or more regions of reduced pressure and/or increased mass flow rate of air within the guide in response to the passage of air through the guide; and a manifold extending from the guide and having at least one exhaust in fluid communication with the one or more regions of reduced pressure and/or increased mass flow rate.

2. An air handling system according to claim 1 in which the air guide comprises a duct.

3. An air handling system according to claim 1 in which the air guide defines a convergent and/or divergent path along which air can flow.

4. An air handling system according to claim 1 in which the air guide comprises a single section having a substantially continuous sidewall.

5. An air handling system according to claim 1 in which the air guide comprises two or more sections separated from one another by a respective circumferentially extending gap.

6. An air handling system according to claim 1 comprising a support on which the air guide is mounted, the manifold extending through or being formed integrally with the support.

7. An air handling system according to claim 3 in which the air guide defines a restricted throat section at or adjacent which the at least one exhaust is located.

8. An air handling system according to claim 1 comprising an air processing unit with which an intake of the manifold is in fluid communication in order to draw air from the air processing unit.

9. An air handling system according to claim 8 in which the air processing unit comprises a heat exchanger in fluid communication with the intake of the manifold.

10. An air handling system according to claim 8 in which the air processing unit comprises a supply duct through which air may be supplied from the air processing unit, and an exhaust duct through which air may be supplied to the air processing unit.

11. An air handling system according to claim 1 comprising a set of blades disposed for rotation in the path defined by the air guide in order to extract power from the flow of air through the guide.

12. An air handling system according to claim 1 in which the manifold passes through the air guide from an exterior to an interior thereof.

13. An air handling system according to claim 8 in which the air processing unit comprises an air conditioning unit.

14. An air handling system according to claim 8 in which the air processing unit comprises a compressor unit.

15. An air handling system according to claim 7 comprising a housing mountable about the air processing unit, the intake being in fluid communication with the housing, and the housing being shaped and/or dimensioned to augment the flow of air into the manifold.
